(19) United States
(12) Patent Application Publication
(10) Pub. No.: US 2011/0164073 A1
(43) Pub. Date: Jul. 7, 2011

(54) METHOD OF DRIVING A DISPLAY AND A DISPLAY USING THE SAME

(75) Inventor: Woon-joong JUNG, Suwon-si (KR)

(73) Assignee: SAMSUNG ELECTRONICS CO., LTD., Suwon-si (KR)

(21) Appl. No.: 12/985,754

(22) Filed: Jan. 6, 2011

(30) Foreign Application Priority Data
Jan. 7, 2010 (KR) 2010-0001264

(51) Int. Cl. G09G 5/10; G09G 3/36

(52) U.S. Cl. 345/690; 345/102

(57) ABSTRACT

A method of driving a display and a display using the same are provided. The display is driven in accordance with one of a plurality of backlight unit (BLU) driving modes for a BLU which provides a display panel with backlight. As a result, an image quality is improved based on respective areas of the display panel.

### CROSS-REFERENCE TO RELATED APPLICATIONS

This application claims priority from Korean Patent Application No. 10-2010-0001264, filed on Jan. 7, 2010 in the Korean Intellectual Property Office, the disclosure of which is incorporated herein by reference in its entirety.

### BACKGROUND

1. Field

Methods and apparatuses relate to driving a display and a display using the same, and more particularly, to driving a display in which degradation of a characteristic of a liquid crystal is resolved, and a display using the same.

2. Description of the Related Art

The recent development of large screen televisions (TVs) enabled viewers to enjoy images on wider screens. The two representative technologies related to the large screen TVs are thin film transistor liquid crystal displays (TFT LCDs) and the plasma display panels (PDPs).

A liquid crystal display (LCD) relates to a display technology which applies electric current to liquid crystals of an anisotropic dielectric constant which is sandwiched in between two panels, and adjusts an amount of light transmitted onto a substrate by adjusting the magnitude of the electric field, so that the array of liquid crystals varies to output an image signal.

Although the LCD has some advantages over the PDP, such as less power consumption and lighter weight, the LCD has a relatively slower response rate because the array of the liquid crystals has to change. In order to resolve the above-mentioned problem of the LCD, many suggestions have been made, such as increasing frame rates, varying a method of driving the LCD, or the like.

Particularly, the slow response rate of the LCD causes motion blur. When motion blur occurs, a viewer sees an afterimage or smearing of a moving image on a video. In other words, the motion blur is the main problem that deteriorates image quality of an LCD in which video image is displayed in the basis of frame unit.

### SUMMARY

Exemplary embodiments overcome the above disadvantages and other disadvantages not described above. Also, the exemplary embodiments are not required to overcome the disadvantages described above, and an exemplary embodiment may not overcome any of the problems described above.

The one or more exemplary embodiment provides a method of driving a display which provides a high resolution image, and a display using the same.

One or more exemplary embodiment also provides a method of driving a display capable of optimizing a quality of image based on a local area of a display panel, and a display using the same.

According to an aspect, there is provided a display, which may include a display panel which displays an input image, a backlight unit (BLU) which provides the display panel with backlight, a storage unit which stores a plurality of BLU driving modes, and a controller which selects one of the plurality of BLU driving modes stored in the storage unit and controls the BLU to be driven according to the selected BLU driving mode.

A first mode of the plurality of BLU driving modes relates to adjusting timings of providing the backlight to a first area and a second area of the display panel equally.

A second mode of the plurality of BLU driving modes relates to adjusting the timings of providing the backlight to the first and the second areas of the display panel differently.

The second mode relates to providing the first and the second areas with the backlight in turn.

If the input image is to be displayed throughout the entire area of the display panel, the controller controls the BLU to be driven according to the second mode.

In the first mode, each of the timings is determined based on a location of an area where a displayed image displayed on the display panel is placed, and the timings are applied differently according to whether the image is placed on a center region or a non-center region of the display panel.

The controller controls the BLU to be driven according to the first mode, if the input image includes a subtitle or a blank on a predetermined portion.

The display according to an exemplary embodiment may additionally include an input unit to receive an image type input, wherein the controller selects a BLU driving mode among the plurality of BLU driving modes which correspond to the input image type by referring to the BLU driving modes stored in the storage unit, and controls the BLU to be driven according to the selected BLU driving mode.

The controller automatically determines an image type of the input image, and drives the BLU based on the determined image type, by referring to the BLU driving modes stored in the storage unit and selecting a BLU driving mode among the plurality of BLU driving modes which corresponds to the determined image type.

The display according to an exemplary embodiment may additionally include an on-screen display (OSD) which sets a BLU driving mode among the plurality of BLU driving modes corresponding to an image type of the input image, wherein the controller controls the BLU to be driven according to the BLU driving mode which is input based on the OSD.

According to another aspect, there is provided a method of driving a display, which may include determining an image type of an input image, selecting one from among a plurality of backlight unit (BLU) driving modes based on the determined image type, and driving the BLU according to the selected BLU driving mode.

A first mode of the plurality of BLU driving modes relates to adjusting timings of providing the backlight to a first area and a second area of a display panel equally.

A second mode of the plurality of BLU driving modes relates to adjusting the timings of providing the backlight to the first and the second areas of the display panel differently.

The second mode relates to providing the first and the second areas with the backlight in turn.

The driving may include driving the BLU according to the second mode, if the input image is a full image which is to be displayed throughout the entire area of the display panel.

In the first mode, each of the timings is determined based on a location of an area where a displayed image displayed on the display panel is placed, and the timings are applied differently according to whether the displayed image is placed in a center region or a non-center region of the display panel.

The driving may include driving the BLU according to the first mode, if the input image includes a subtitle or a blank on a predetermined portion.

The method according to an exemplary embodiment may additionally include receiving an image type input, wherein the driving comprises selecting a BLU driving mode among the plurality of BLU driving modes which corresponds to the input image type, and driving the BLU according to the selected BLU driving mode.

The method according to an exemplary embodiment may additionally include storing the plurality of BLU driving modes which individually correspond to a different image type of the input image, wherein the driving comprises automatically determining the image type of the input image, selecting a BLU driving mode among the plurality of BLU driving modes which corresponds to the determined image type by referring to the stored BLU driving modes, and driving the BLU based on the selected BLU driving mode.

The method according to an exemplary embodiment may additionally include generating an on-screen display (OSD) which sets a BLU driving mode among the plurality of BLU driving modes corresponding to an image type of the input image, wherein the driving comprises driving the BLU according to the BLU driving mode which is input based on the OSD.

### BRIEF DESCRIPTION OF THE DRAWINGS

The above and/or other aspects will be more apparent by describing certain exemplary embodiments with reference to the accompanying drawings, in which:

FIG. 1 is a schematic view of an image output apparatus according to an exemplary embodiment;

FIG. 2 is a schematic view of a television (TV) according to an exemplary embodiment;

FIG. 3A is a schematic view illustrating a blinking processing according to an exemplary embodiment;

FIG. 3B is a schematic view illustrating a scanning processing according to an exemplary embodiment;

FIG. 4A is a schematic view illustrating a displaying method according to an exemplary embodiment;

FIG. 4B is a schematic view illustrating a displaying method according to an exemplary embodiment;

FIG. 5A is a schematic view illustrating a displaying method according to an exemplary embodiment;

FIG. 5B is a schematic view illustrating a displaying method according to an exemplary embodiment;

FIG. 5C is a schematic view illustrating a displaying method according to an exemplary embodiment;

FIG. 6 is a flowchart illustrating a displaying method according to an exemplary embodiment; and

FIG. 7 is a schematic view of an on-screen display (OSD) according to an exemplary embodiment.

### DETAILED DESCRIPTION OF EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the disclosure with unnecessary detail.

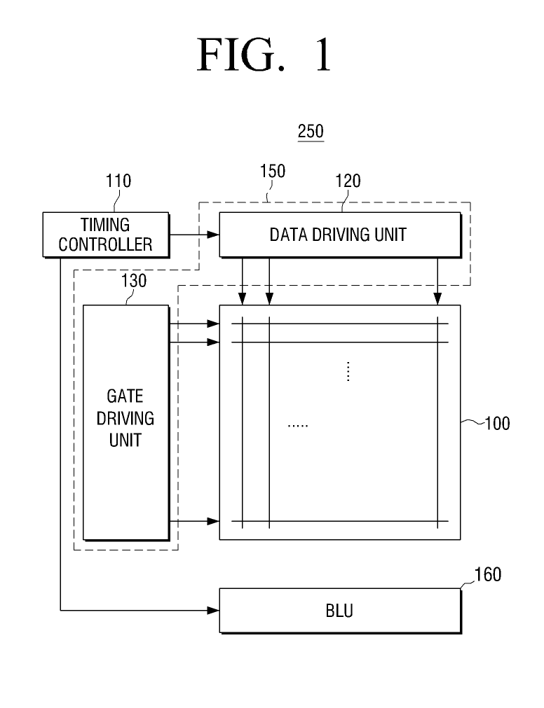

FIG. 1 is a schematic view illustrating a structure of an image output apparatus according to an exemplary embodiment.

Referring to FIG. 1, the image output apparatus 250 may include a panel unit 100, a timing controller 110, a driving unit 150, and a backlight unit (BLU) 160.

The panel unit 100 may include a plurality of gate lines (e.g., disposed in the horizontal direction) and a plurality of data lines (e.g., disposed in the vertical direction), and a plurality of pixels formed on areas where the gate and data lines cross each other.

The data lines receive input data voltage, which is changed from gradation data, from a data driving unit 120 and apply the data voltage to the pixels. The gate lines receive gate-ON-voltage input, and apply the gate-ON-voltage to the pixels. The pixels are formed on areas where the gate lines to apply gate-ON-voltage and the data lines to apply data voltage cross each other.

The timing controller 110 may transfer a current frame to the driving unit 130 so that the panel unit 100 is driven in the manner explained above.

The timing controller 110 may receive an external image signal and process the data. Specifically, the timing controller 110 may receive red, green and blue (RGB) data, a data enable signal representing a time point of the frame, a synchronous signal and a clock signal, and generate a control signal such as a gate start pulse (GSP) or a source start pulse (SSP). Herein, the GSP signal indicates a time point when the data from among a vertical synchronous signal (Vsync) is applied to the first gate line, and the SSP signal indicates a time point when the data from among a horizontal synchronous signal (Hsync) is applied to the first source line.

According to the GSP and/or SSP signal output from the timing controller 110, it is determined whether or not backlight is provided to the panel unit 110 and a timing of providing the backlight.

At this time, a manner of driving a backlight is also determined in accordance with the image displayed on the panel unit 100. Specifically, if image is displayed throughout the entire area of the panel unit 100, the panel area is divided and the backlight is provided to the divided sub-areas in turn. If the displayed image is concentrated on a specific area of the panel unit 100, turning on and off the backlight is controlled in an alternating manner with respect to the entire area of the panel unit 100. The alternating control on the turning on and off the backlight may be accomplished by controlling the timing of turning off the backlight with a predetermined periodicity.

Particularly if a BLU driving mode which provides backlight to the entire area of the panel unit 100 is used, each area has a different reduction of motion blur phenomenon, depending on the timing of turning off the backlight. Accordingly, by adjusting the timing of turning on/off the backlight as explained above, the resultant image can have an optimized liquid crystal characteristic in each area of the panel unit 100.

By way of example, if the image is displayed only in a center portion of the panel unit 100, the liquid crystal characteristic in the center portion of the panel unit 100 can be optimized by appropriately adjusting a turn-off timing or a turn on/off timing of the backlight. Additionally, if the image is displayed throughout the entire area of the panel unit 100, in addition to any data thereon, such as a subtitle that usually draws more of viewer's attention, the turn-off timing can be adjusted in a way that the liquid crystal characteristic in the upper and lower areas of the panel unit 100 are optimized.

The term ‘optimizing liquid crystal characteristic’ herein may refer to resolving the problem such as motion blur due to a slow response rate of the liquid crystal.

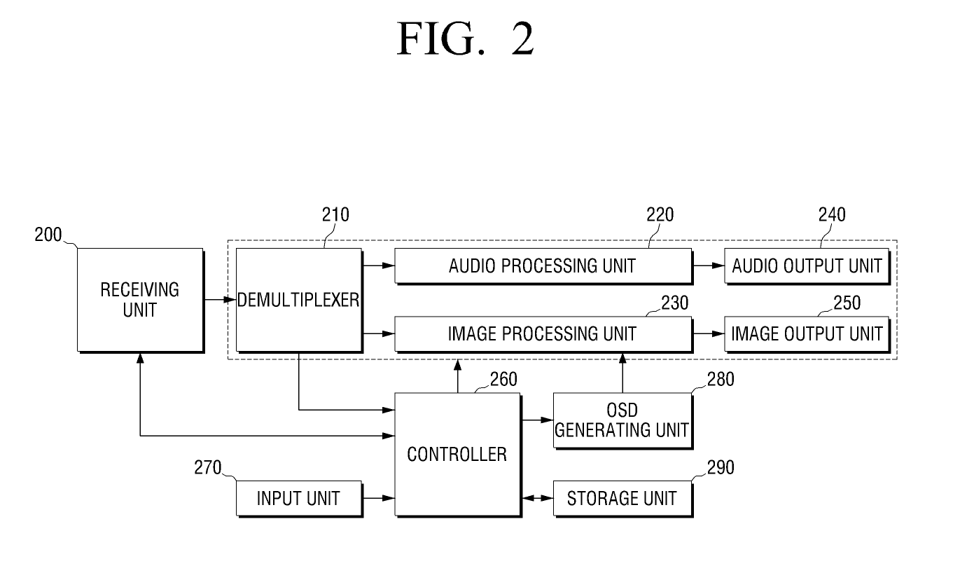

FIG. 2 is a block diagram of a display device (e.g. a TV) according to an exemplary embodiment. Referring to FIG. 2, the display according to an exemplary embodiment may include a receiving unit 200, a demultiplexer 210, an audio processing unit 220, an image processing unit 230, an audio output unit 240, an image output unit 250, a controller 260, an input unit 270, an on-screen display (OSD) generating unit 280, and a storage unit 290.

The receiving unit 200 may receive a broadcast signal by wire or wirelessly, and provide the demultiplexer 210 with the received broadcast signal. Specifically, the receiving unit 200 may provide the demultiplexer 210 with a broadcast signal wirelessly received from a broadcast provider, or a broadcast signal received from a DVD or from a set top box via cable.

The demultiplexer 210 may divide a broadcast signal output from the receiving unit 200 into an image signal and an audio signal, and output the divided signals to the audio processing unit 220 and the image processing unit 230, respectively.

The audio processing unit 220 may decode the audio signal separated at the demultiplexer 210 to change the audio signal to the correct output format compatible for handling by the audio output unit 240, and transfer the changed audio signal to the audio output unit 240. The image processing unit 230 may decode the image signal separated at the demultiplexer 210, change the image signal to the correct output format compatible for handing by the image output unit 250, and provide the changed image signal to the image output unit 250.

The audio output unit 240 may output the audio signal input from the audio processing unit 220, and the image output unit 250 may output the image signal input from the image processing unit 230.

Meanwhile, the input unit 270 may generate an input command according to a user's manipulation, and provide the controller 260 with the generated input command. The signal input provided to the input unit 270 may be a signal which is input by the user through a keypad integrally formed on the display, or a signal which is input through a remote controller provided separately from the main body of the display.

The OSD generating unit 280 may cause an OSD menu to be displayed, or request a user for an input signal through the OSD menu. In particular, the OSD generating unit 280 may generate an OSD with which a user can select desired environment settings for the display, a desired way of driving the BLU suitable for an input image, or the like.

The controller 260 may control the receiving unit 200 to receive a broadcast signal, control the demultiplexer 210 to divide the received broadcast signal and decode the divided signal, or control the overall operations of the audio processing unit 220, the audio output unit 240, the image processing unit 230, the image output unit 250, the OSD generating unit 280, and the storage unit 290.

Specifically, the controller 260 may control the timing controller 110, the driving unit 150, and the panel unit 100 illustrated in FIG. 1, by analyzing the image signal received from the demultiplexer 210 and determine a desired mode of controlling the BLU 160 according to the determination.

Meanwhile, the controller 260 may select a mode of driving the backlight according to the image displayed on the panel unit 100, and control the BLU 160 accordingly. The modes of driving the backlight based on the image displayed on the panel unit 100, may be previously stored in the storage unit 290, which will be explained below.

Specifically, if the image is displayed throughout the entire area of the panel unit 100, the panel may be divided into sub-areas so that the backlighting is provided to the respective sub-areas in turn. If the image is concentrated at a specific area on the panel unit 100, or if the image is displayed throughout the entire area of the panel unit 100, but with the addition of specific information thereon, such as subtitles, turning on and off the backlight is controlled alternately with respect to the entire area of the panel unit 100. Controlling the turning on and off of the backlight alternately may be carried out by controlling the turn-off timing, or the turn on/off timing, of the backlight with a predetermined periodicity.

Particularly, if a BLU driving mode to provide backlight to the entire area of the panel unit 100 is used, since the area of optimized liquid crystal characteristic varies according to the turn-off timing, the main area on the panel unit 100 (i.e., where the viewer's attention is mostly likely to be focused) can have the optimized liquid crystal characteristic as the turn-off timing is adjusted.

Meanwhile, the storage unit 290 may store a plurality of BLU driving modes. In other words, the storage unit 290 may store the most optimum BLU driving mode for each type of the input image.

Referring to the plurality of BLU driving modes stored in the storage unit 290, the controller 260 selects a corresponding BLU driving mode for the image type received from the input unit 270, and controls the backlight accordingly. Also referring to the plurality of stored BLU driving modes of the storage unit 290, the controller 260 may determine the type of the input image automatically, select a corresponding BLU driving mode of the BLU driving modes stored in the storage unit 290, and control the backlight based on the selected corresponding BLU driving mode.

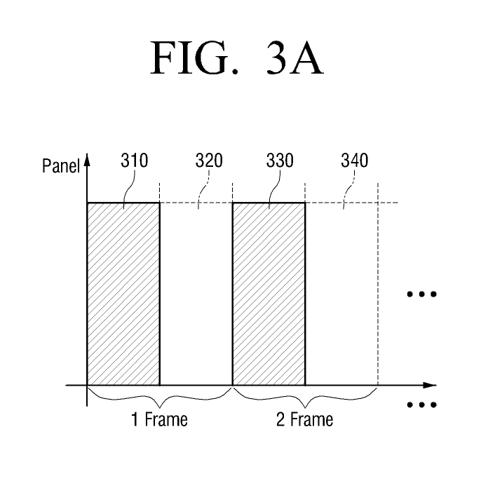

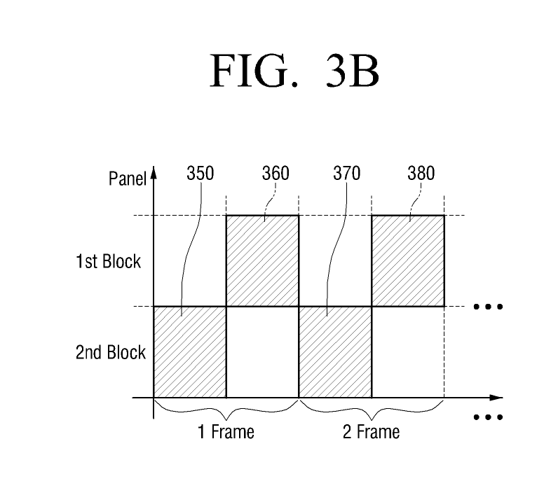

FIGS. 3A and 3B are schematic views illustrating a displaying method according to an exemplary embodiment.

FIG. 3A particularly illustrates a mode of inserting a black frame by alternately controlling turning on and off the backlight within one frame with respect to the entire area of the display panel. In other words, the BLU may apply a ‘black insertion’ mode, with which the same effect as inserting a black frame is obtained by appropriately controlling turning on and off the backlight using the understanding that a frame is not indicated on the screen when the backlight is turned off. Accordingly, the black insertion improves liquid crystal characteristic and reduces motion blur of a LCD.

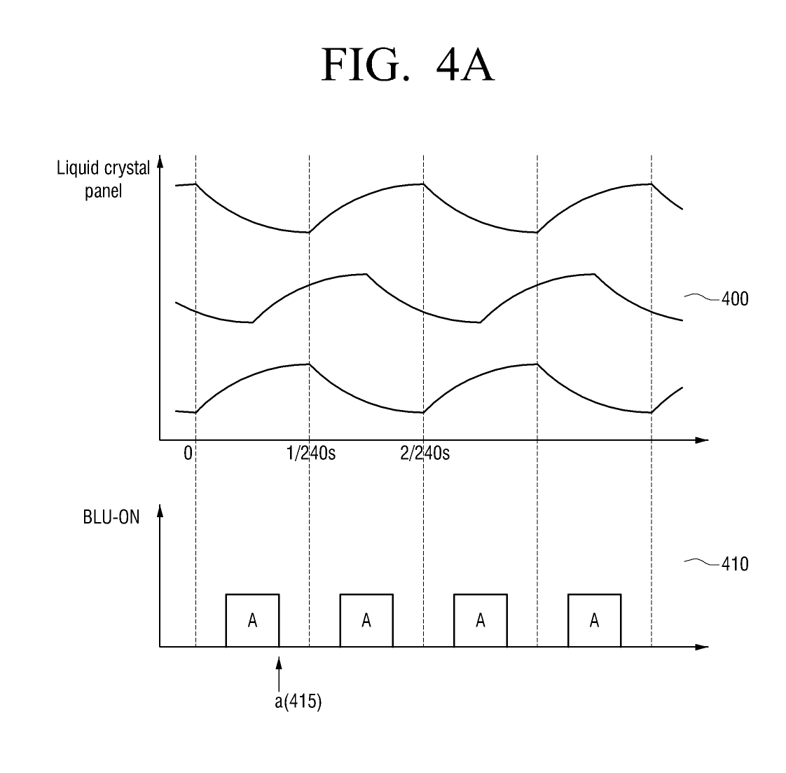

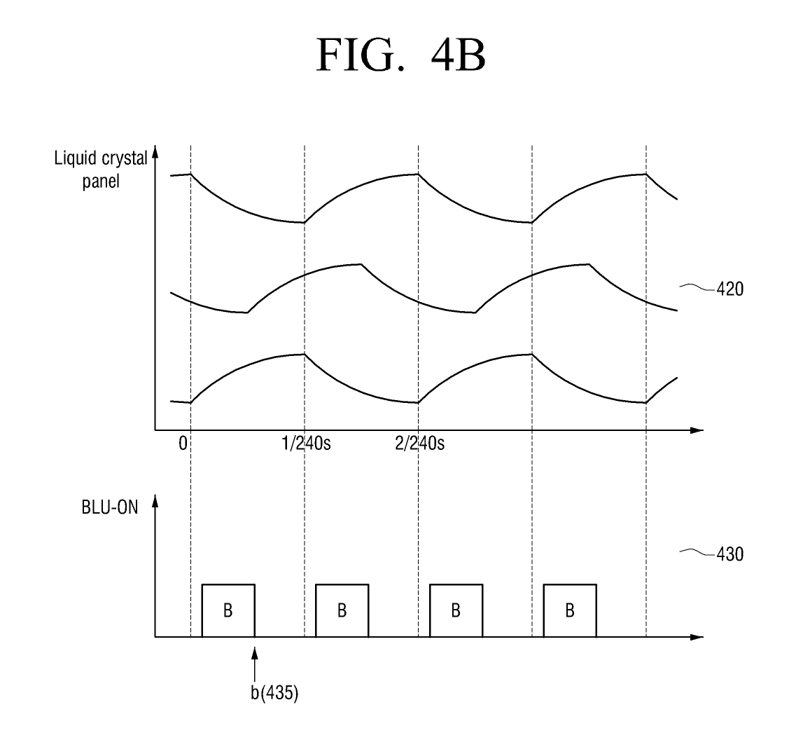

Accordingly, backlight is provided to the entire display panel based on alternately turning on and off the backlight, so that the backlight is turned ON (310) and OFF (320) in the first frame, and turned ON (330) and OFF (340) again as the frame changes to the second frame. The timing of turning off the backlight within the frame is changeable, and the liquid crystal characteristic of each specific area on the screen can be enhanced by adjusting this turn-off timing. This will be explained in detail below with reference to FIGS. 4A and 4B.

Meanwhile, FIG. 3B illustrates a mode of dividing a display panel into a plurality of areas and varying the timing of providing backlight depending on each area. By way of example, it is assumed that the display panel is divided into a first block area and a second block area to be provided with backlight. The first block may correspond to the upper area of the display panel, and the second block may correspond to the lower area of the display panel.

When the first frame is applied to the display panel, the backlight is in ON (350) in the second block (e.g., the lower area of the display panel) and OFF in the first block (e.g., the upper area of the display panel). When the backlight is turned off in the second block, the backlight is turned ON (360) in the first block. Likewise, in the second frame, if the first block is turned OFF, the second block is turned ON (370), and if the second block is turned OFF, the first block is turned ON (380). As the turning-off timing of the backlight is adjusted depending on blocks, the effect of inserting a black frame alternately in each area, is obtained.

Accordingly, by periodically inserting black frames to the screen using the two modes explained above with reference to FIGS. 3A and 3B, problems associated with slow liquid crystal response of the LCD, such as motion blur, can be minimized.

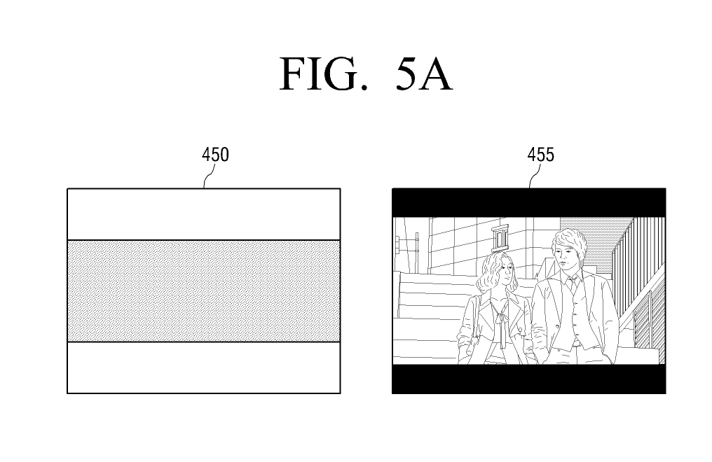

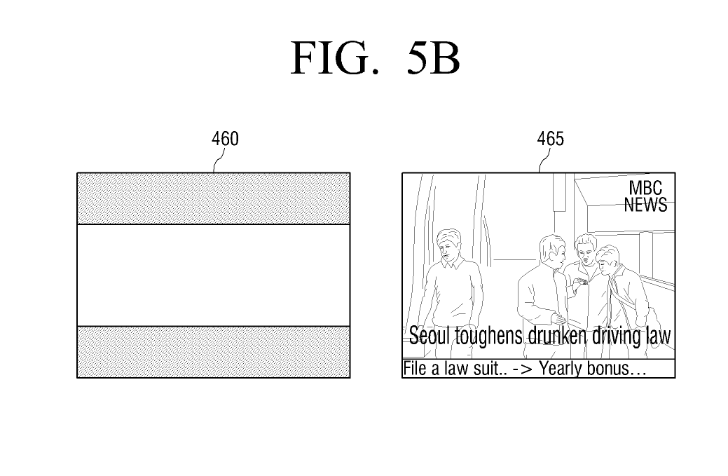

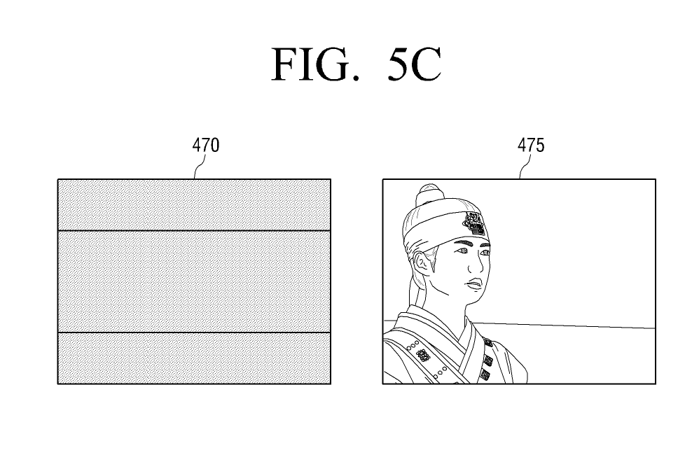

A displaying method according to an exemplary embodiment will be explained in detail below, with reference to FIGS. 4A, 4B, and 5A to 5C.

FIGS. 4A and 4B are schematic views which explain in more detail a displaying method according to an exemplary embodiment. Particularly, FIGS. 4A and 4B illustrate a specific mode of turning on and off a backlight with respect to the entire area of the liquid crystal panel according to a predetermined period. For convenience of explanation, this specific mode will be referred to as a ‘blinking mode’ hereinbelow. Also for convenience of explanation, it is assumed that the frame rate is 240 Hz, meaning one frame is applied to the liquid crystal panel in every 1/240 seconds. Although it is possible that the image signal is scanned from top to bottom or vice versa of the liquid crystal panel, for convenience of explanation, it is assumed that the image signal is scanned from bottom to top of the panel.

Each of the graphs 400, 420 on the upper sides of FIGS. 4A and 4B, respectively, represents scanning of an image signal from bottom to top of the liquid crystal panel according to time. As indicated by the upper graphs 400, 420, there is a time difference in applying the frames depending on the location of the liquid crystal panel. That is, the image signal is applied to the lowest portion of the panel fastest, and gets slower toward the upper side of the panel.

The backlight is provided after the image signal is applied to the liquid crystal panel to display the signal, and graphs 410, 430 on the lower sides of FIGS. 4A and 4B, respectively, illustrate the timing of providing the backlight to the liquid crystal panel. Specifically, the backlight is provided during pulse A and B in FIGS. 4A and 4B, respectively, and the backlight is off the remaining time.

In blinking mode, the backlight is turned on and off, turned back on and off, and so on, as indicated by the lower graphs 410, 430 of FIGS. 4A and 4B. Herein, the area to have an enhanced liquid crystal characteristic can be changed, by varying the timing of turning off the backlight within the frame. Using this, it is possible to enhance the liquid crystal characteristic of a specific area which is currently viewed most frequently by the viewers and thus provide the viewers with high resolution display.

FIGS. 4A and 4B illustrate the controlling of the turn-off timing, and FIGS. 5A and 5B illustrate a screen with improved liquid crystal characteristic according to the turn-off timing.

Referring to FIG. 4A, in a state that an image signal is applied and the backlight is on, the backlight is turned off when a turn-off signal is applied at a time point a (415). With reference to FIG. 4B, in a state that an image signal is applied and the backlight is on, the backlight is turned off when a turn-off signal is applied at a time point b (435).

By setting the timing of initiating turning off of the backlight differently, that is, by setting a phase of turning off the backlight differently, different areas on the liquid crystal panel can have optimized liquid crystal characteristic.

FIG. 5A illustrates a display 450 on a left side where the center portion of the liquid crystal panel has the optimized liquid crystal characteristic, and FIG. 5B illustrates a display 460 also on a left side where the upper and lower portions of the liquid crystal panel have the optimized liquid crystal characteristics. By using the blinking mode, that is, by setting the backlight turn-off timing differently as necessary, it is possible to optimize the liquid crystal characteristic of a specific area of the liquid panel.

That is, if the input image is output through the center portion of the liquid crystal panel, which is not an entire area of the liquid crystal panel, and in consideration that the viewers are mostly likely to focus on the center portion, the backlight turn-off timing is adjusted so that the liquid crystal characteristic of the center portion of the liquid crystal panel is optimized and the image is displayed. This method may be particularly suitable for a 16:9 film image 455 in which the center portion of the liquid crystal panel receives more of the viewer's attention.

If the viewers focus more on upper and lower portions of the liquid crystal panel, by adjusting the backlight turn-off timing, a display 460 on the left side of FIG. 5B in which liquid crystal characteristic on the upper and lower portions is optimized, may be provided. This example may be suitable for a news broadcast in which most of the viewer's attention is focused on the subtitles displayed in the lower portion of the liquid crystal panel.

Meanwhile, the liquid crystal panel may be divided into sub-areas and the backlight may be driven in a manner of providing backlight to the respective sub-areas in turns. That is, the above mode or ‘scanning mode’ provides the backlight in turns in the manner of scanning the sub-areas sequentially.

According to the above scanning mode, the liquid crystal is optimized 470 with respect to the entire area of the liquid crystal panel (FIG. 5C). The scanning mode may be suitable for an image type 475 which is output throughout the entire area of the liquid crystal panel.

The appropriate BLU driving modes for different image types 455, 465, 475, such as blinking mode or scanning mode, and the turn-off timings for the blinking mode which are adjusted for the corresponding different image types (e.g., image types 455 and 465) may be stored in the storage unit 290 in advance, so that the controller 260 refers to the BLU driving modes stored in the storage unit 290 to drive the backlight appropriately. The controller 260 selects the appropriate BLU driving mode according to a signal input from the input unit. Alternatively, the controller 260 selects the appropriate BLU driving mode by automatically determining the image type from the image signal input from the demultiplexer 210 and automatically determines and selects the BLU driving mode which corresponds to the determined image type.

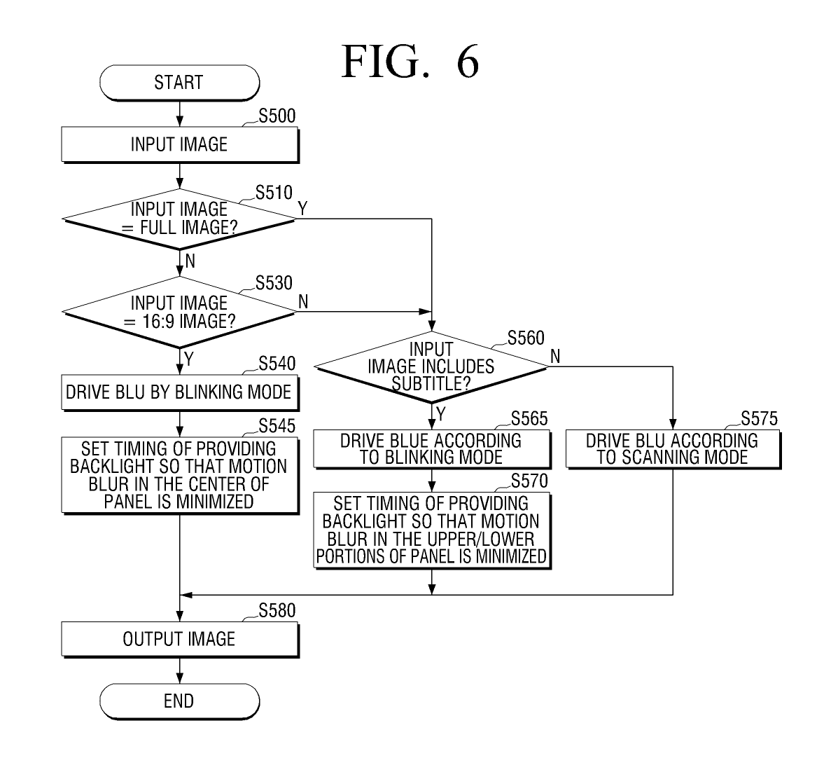

FIG. 6 is a flowchart illustrating a displaying method according to an exemplary embodiment of the present invention.

At S500, an image to be output to the display panel is received. At S510, it is determined whether the input image is a full image, that is, if the image is to be displayed throughout the entire area of the display panel. At S510-N, if the input image is not the full image, at S530, it is determined if the image is a 16:9 image (i.e., an image which is displayed in a center portion of the display panel).

At S540, if the input image is 16:9 image (S530-Y), the BLU is driven according to the blinking mode. At S545, an appropriate backlight turn-off timing is set for providing the backlight, so that the liquid crystal characteristic in the center portion of the display panel can be optimized and the motion blur in the center portion can be minimized. At S580, as the backlight is supplied, the image applied to the display panel is displayed.

At S530-N, if the input image is other than 16:9 image, it is determined at S560 if the image includes subtitles. Since the operations following hereinafter are identical to those performed when the input image is determined to be a full image (S510-Y), for convenience of explanation, the operations following determination of the input image as a full image (S510-Y) will be representatively explained.

At S510-Y, if the input image is determined to be a full image, it is determined at S560 if the input image includes subtitles, and at S560-N, if the input image does not include subtitles, the BLU is driven in scanning mode at S575, and the image is output at S580.

But if the input image includes subtitles at 5560-Y, the BLU is driven according to the blinking mode at S565. In this case, at S570, a backlight turn-off timing to optimize the liquid crystal characteristic of the upper and lower portions of the display panel, and to thus minimize motion blur of these upper and lower portions, is set, and backlight is provided accordingly. At 5580, the backlight is supplied and the image applied to the display panel is displayed accordingly.

As explained above, since a BLU driving mode is differently set according to the type of the input image, viewers are provided with optimized image quality. In addition, in the blinking mode, the backlight turn-off timing used to optimize the liquid crystal characteristic in the center portion of the display panel may be different than the backlight turn-off timing used to optimize the liquid crystal characteristic in the upper and lower portions of the display panel, since the liquid crystal characteristics of the lower, center and upper portions are optimized according to different turn-off timings.

Although the full image, the 16:9 image, or the image including subtitles are described as examples of image types in the exemplary embodiments explained above, it should be noted that these are used as examples to explain different areas of the screen that receive a viewer's attention more than the others, and the concept of the disclosure is not limited to these examples only.

Furthermore, although the optimization of the liquid crystal characteristic refers mainly to the minimization of motion blur in the examples described above, it should be noted that the optimization of the liquid crystal characteristic may be interpreted as minimizing degradation of liquid crystal due to a slow response rate.

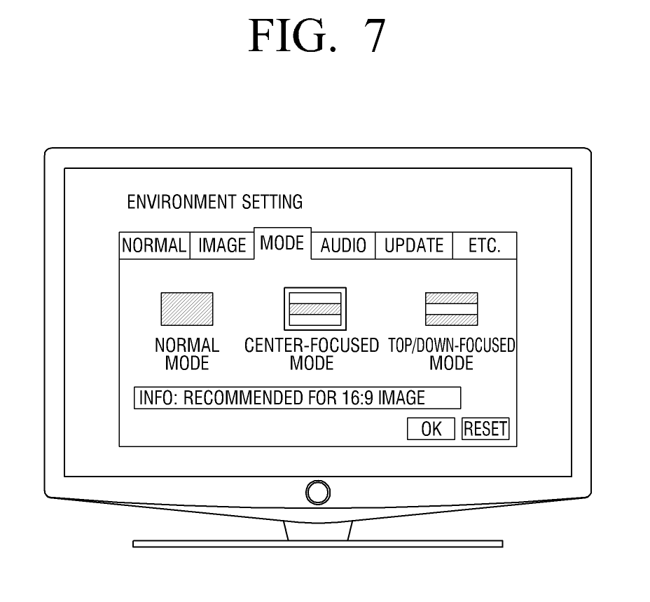

FIG. 7 illustrates the structure of the OSD to set a BLU driving mode according to an exemplary embodiment.

Referring to FIG. 7, an image may be displayed in a normal mode, if the viewer watches the entire area, or the image may be displayed in a center-focused mode, if the viewer's attention is focused on the center portion of the panel. Additionally, the image may be displayed in a top/down-focused mode, if the viewer's attention is focused on the upper and lower portions of the panel. The user may set one of the modes through the input unit 270, where each mode shown in FIG. 7 corresponds to a different BLU driving mode and backlight turn-off timing. For example, setting the normal mode may set the BLU driving mode and backlight turn-off timing which corresponds to FIG. 5C. Similarly, setting the center-focused mode or the top/down-focused mode may set the BLU driving mode and backlight turn-off timing corresponding to FIGS. 5A and 5B, respectively.

Although the normal mode, the center-focused mode, and the top/down-focused modes are explained as the examples of the BLU driving modes according to an exemplary embodiments, it should be noted that the other appropriate terms may be used to refer to the respective BLU driving modes. Furthermore, the structure of the OSD is not limited to that illustrated in FIG. 7, but a variety of structures may be applied.

As described above, according to an exemplary embodiment, high-resolution image is provided, and particularly, the image is provided with different areas of the display panel having an optimized image quality.

The foregoing exemplary embodiments and advantages are merely exemplary and are not to be construed as limiting. The present teaching can be readily applied to other types of apparatuses and display devices. Also, the description of the exemplary embodiments is intended to be illustrative, and not to limit the scope of the claims, and many alternatives, modifications, and variations will be apparent to those skilled in the art.

What is claimed is:

1. A display, comprising:
a display panel which displays an input image;
a backlight unit (BLU) which provides the display panel with backlight;
a storage unit which stores a plurality of BLU driving modes; and
a controller which selects one of the plurality of BLU driving modes stored in the storage unit and controls the BLU to be driven according to the selected one of the plurality of BLU driving modes.

2. The display of claim 1, wherein a first mode of the plurality of BLU driving modes relates to adjusting timings of providing the backlight to a first area and a second area of the display panel equally.

3. The display of claim 2, wherein a second mode of the plurality of BLU driving modes relates to adjusting the timings of providing the backlight to the first and the second areas of the display panel differently.

4. The display of claim 3, wherein the second mode relates to providing the first and the second areas with the backlight in turn.

5. The display of claim 3, wherein the controller controls the BLU to be driven according to the second mode, if the input image is a full image which is to be displayed throughout an entire area of the display panel.

6. The display of claim 2, wherein, in the first mode, each of the timings is determined based on a location of an area where a displayed image displayed on the display panel is placed, and the timings are applied differently according to whether the displayed image is placed in a center region or a non-center region of the display panel.

7. The display of claim 2, wherein the controller controls the BLU to be driven according to the first mode, if the input image includes a subtitle or a blank on a predetermined portion.

8. The display of claim 1, further comprising an input unit to receive an image type input, wherein the controller selects a BLU driving mode among the plurality of BLU driving modes which corresponds to the input image type by referring to the BLU driving modes stored in the storage unit, and controls the BLU to be driven according to the selected BLU driving mode.

9. The display of claim 1, wherein the controller automatically determines an image type of the input image, and drives the BLU based on the determined image type, by referring to the BLU driving modes stored in the storage unit and selecting a BLU driving mode among the plurality of BLU driving modes which corresponds to the determined image type.

10. The display of claim 1, further comprising an on-screen display (OSD) which sets a BLU driving mode among the plurality of BLU driving modes corresponding to an image type of the input image, wherein the controller controls the BLU to be driven according to the BLU driving mode which is input based on the OSD.

11. A method of driving a display, the method comprising:
determining an image type of an input image;
selecting one from among a plurality of backlight unit (BLU) driving modes based on the determined image type; and
driving the BLU according to the selected BLU driving mode.

12. The method of claim 11, wherein a first mode of the plurality of BLU driving modes relates to adjusting timings of providing the backlight to a first area and a second area of a display panel equally.

13. The method of claim 12, wherein a second mode of the plurality of BLU driving modes relates to adjusting the timings of providing the backlight to the first and the second areas of the display panel differently.

14. The method of claim 13, wherein the second mode relates to providing the first and the second areas with the backlight in turn.

15. The method of claim 13, wherein the driving comprises driving the BLU according to the second mode, if the input image is a full image which is to be displayed throughout an entire area of the display panel.

16. The method of claim 12, wherein, in the first mode, each of the timings is determined based on a location of an area where a displayed image displayed on the display panel is placed, and the timings are applied differently according to whether the displayed image is placed in a center region or a non-center region of the display panel.

17. The method of claim 12, wherein the driving comprises driving the BLU according to the first mode, if the input image includes a subtitle or a blank on a predetermined portion.

18. The method of claim 11, further comprising receiving an image type input, wherein the driving comprises selecting a BLU driving mode among the plurality of BLU driving modes which corresponds to the input image type, and driving the BLU according to the selected BLU driving mode.

19. The method of claim 11, further comprising storing the plurality of BLU driving modes which individually correspond to a different image type of the input image, wherein the driving comprises automatically determining the image type of the input image, selecting a BLU driving mode among the plurality of BLU driving modes which corresponds to the determined image type by referring to the stored BLU driving modes, and driving the BLU based on the selected BLU driving mode.

20. The method of claim 11, further comprising generating an on-screen display (OSD) which sets a BLU driving mode among the plurality of BLU driving modes corresponding to an image type of the input image, wherein the driving comprises driving the BLU according to the BLU driving mode which is input based on the OSD.

21. A display, comprising:
a display panel which displays an input image;
a backlight unit (BLU) which provides the display panel with backlight;
a storage unit which stores a plurality of BLU driving modes; and
a controller which selects one of the plurality of BLU driving modes stored in the storage unit based on an image type of the input image and controls the BLU to be driven according to the selected BLU driving mode,
wherein the plurality of BLU driving modes comprises:
a blinking mode in which the controller controls the BLU to be driven such that turning on and off of the BLU is controlled alternately with respect to an entire area of the display panel, and
a scanning mode in which the controller divides the display panel into a plurality of sub-areas and controls the BLU to be driven such that the backlight is provided to the plurality of sub-areas sequentially.

22. The display of claim 21, wherein the controller selects the blinking mode, if the image type of the input image is either not a full image which is not to be displayed throughout the entire area of the display panel or an image which includes subtitles, and
the controller selects the scanning mode, if the image type is a full image which is to be displayed throughout the entire area of the display panel and which does not include subtitles.

23. The display of claim 22, wherein the blinking mode comprises a plurality of sub-modes to be selected by the controller based on the image type of the input image, wherein the plurality of sub-modes have different turn-off timings configured to optimize a liquid crystal characteristic of different areas of the display panel.

24. The display of claim 23, wherein each of the turn-off timings is set based on a location of an area where a displayed image displayed on the display panel is placed, and the turn-off timings are applied differently according to whether the displayed image is placed in a center region or a non-center region of the display panel.

25. The display of claim 22, wherein the controller receives the input image, analyzes the input image, automatically determines the image type of the analyzed input image, selects a BLU driving mode among the plurality of BLU driving modes which corresponds to the determined image type, and drives the BLU according to the selected BLU driving mode.
